(19) United States
(12) Patent Application Publication
(10) Pub. No.: US 2011/0280326 A1
(43) Pub. Date: Nov. 17, 2011

(54) METHOD FOR CLUSTERING MULTIPLE STATIONS

(75) Inventors: YUNG SZU TU, Hsinchu County (TW); YEN CHIN LIAO, Hsinchu County (TW); CHENG HSUAN WU, Hsinchu County (TW)

(73) Assignee: RALINK TECHNOLOGY CORPORATION, Hsinchu County (TW)

(21) Appl. No.: 13/025,886

(22) Filed: Feb. 11, 2011

Related U.S. Application Data
(60) Provisional application No. 61/345,079, filed on May 15, 2010.

(51) Int. Cl. H04L 27/28

(52) U.S. Cl. 375/260

(57) ABSTRACT

A method for clustering multiple stations for a MIMO communication system comprises the steps of: assigning a plurality of stations of a MIMO communication system to a plurality of clusters, wherein each station is assigned to at least one cluster, and at least one cluster is assigned with more than one station; and assigning the plurality of clusters to a plurality of sets, wherein each cluster is assigned to a set.

### BACKGROUND OF THE INVENTION

1. Field of the Invention

The present invention relates to a method for clustering multiple stations.

2. Description of the Related Art

Wireless local area network (WLAN) is widely used to provide access to the internet with mobile devices. To improve the throughput in WLAN, some standards, such as the Institute of Electrical and Electronics Engineers to (IEEE) 802.11n standard, adopt the multiple input multiple output (MIMO) system that transmits a plurality of data streams with multiple antennas and, at the same time, receives a plurality of data streams with multiple antennas. However, most of the current standards are still based on a point-to-point transmission scheme. When there are more stations connected to an access point (AP), each station has to hold the transmission and wait for an empty time slot.

Accordingly, a multi-user (MU), or multi-station, transmission system with MIMO system is proposed. In a MU-MIMO system, the AP can transmit data to multiple stations with a single antenna or multiple antennas simultaneously such that more stations can be served by the AP at the same time. However, when MU-MIMO signals are transmitted, several stations may be targeted in the same packet. Therefore, it is desirable for such targeted stations to be specified as soon as possible. In addition, it is also desirable that the list of targeted stations can be changed quickly.

### SUMMARY OF THE INVENTION

One object of the present invention is to provide a method for clustering stations. The method comprises first clustering a plurality of stations into a plurality of clusters. The clusters are then grouped into several sets. A signal is sent from an access point to the sets. The clusters of stations can then compare the media access control (MAC) information inside the signal to determine whether to process the received signal.

The method of clustering multiple stations for a MIMO communication system according to one embodiment of the present invention comprises the steps of: assigning a plurality of stations of a MIMO communication system to a plurality of clusters, wherein each station is assigned to at least one cluster, and at least one cluster is assigned with more than one station; and assigning the plurality of clusters to a plurality of sets, wherein each cluster is assigned to a set.

The communication method for a MIMO communication system according to one embodiment of the present invention comprises a step of: transmitting a plurality of data streams conforming to a MIMO communication system, wherein each data stream comprises a same signal field indicating which stations of the MIMO communication system are to receive the data stream. The signal field comprises information including an ID of one of a plurality of sets and a partition of the plurality of data streams, wherein the ID of the set indicates which stations are to receive the data streams and the partition of the plurality of data streams indicates which data streams are to be received by the stations. Each set comprises IDs of a plurality of clusters, each cluster comprises at least one station of the MIMO communication system, and at least one cluster comprises more than one station of the MIMO communication system.

The foregoing has outlined rather broadly the features and technical advantages of the present invention in order that the detailed description of the invention that follows may be better understood. Additional features and advantages of the invention will be described hereinafter, and form the subject of the claims of the invention. It should be appreciated by those skilled in the art that the conception and specific embodiment disclosed may be readily utilized as a basis for modifying or designing other structures or processes for carrying out the same purposes as those of the present invention. It should also be realized by those skilled in the art that such equivalent constructions do not depart from the spirit and scope of the invention as set forth in the appended claims.

### BRIEF DESCRIPTION OF THE DRAWINGS

The objectives and advantages of the present invention will become apparent upon reading the following description and upon referring to the accompanying drawings of which:

FIG. 1 shows a flowchart of the method for clustering multiple stations and the communication method thereof for a MIMO communication system according to an embodiment of the present invention;

FIG. 2 shows a clustering assignment of a plurality of stations of a MIMO communication system according to an embodiment of the present invention;

FIG. 3 shows the structure of a signal field according to an embodiment of the present invention; and

FIG. 4 shows a signal field according to an embodiment of the present invention.

### DETAILED DESCRIPTION OF THE INVENTION

In a MU-MIMO system according to the present invention, a cluster may be defined as one or more stations that map to the same cluster ID. The stations in the same cluster ID may have high spatial interference with each other. That is, the correlations between the stations in a cluster are above a threshold value. Preferably, the spatial correlations between the stations in a cluster are above a threshold value. In addition, some clusters may contain only one station. Since stations with high spatial interference are grouped together, one station of each cluster can be the targeted station in a MU-MIMO transmission. All stations within the same cluster decode the signals targeted for this cluster and verify the MAC-ID or MAC address to determine whether they are the targeted stations.

In a MU-MIMO system according to the present invention, a set may be defined as a group of clusters. The mapping from cluster IDs to a set ID may be predetermined. The set ID and the number of space-time streams for each cluster may be specified in the preamble.

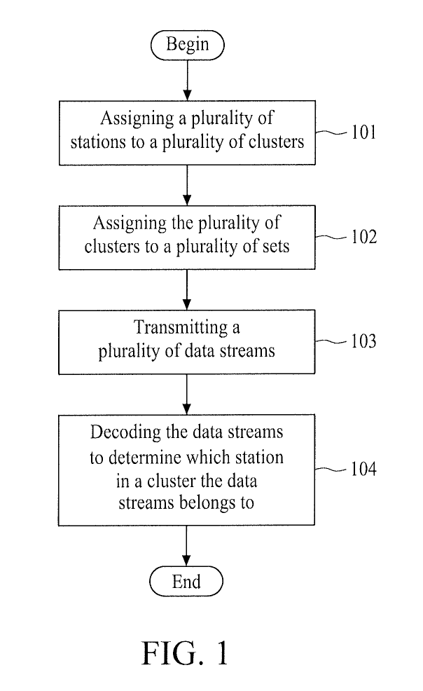

FIG. 1 shows a flowchart of the method for clustering multiple stations and the communication method thereof for a MIMO communication system according to an embodiment of the present invention. In step 101, a plurality of stations of a MIMO communication system are assigned to a plurality of clusters, wherein each station is assigned to at least one cluster and at least one cluster is assigned with more than one station, and step 102 is executed. In step 102, the plurality of clusters are assigned to a plurality of sets, wherein each cluster is assigned to a set, and step 103 is executed. In step 103, a plurality of data streams conforming to the MIMO communication system are transmitted, wherein each data stream comprises a same signal field indicating which stations of the MIMO communication system are to receive the data stream, and step 104 is executed. In step 104, a plurality of data streams are decoded by every station of a cluster in the set indicated by the signal field to determine which station of the cluster the data stream belongs to.

It should be noted that the signal field comprises information including an ID of one of a plurality of sets and a partition of the plurality of data streams, wherein the ID of the set indicates which stations are to receive the data streams and the partition of the plurality of data streams indicates which data streams are to be received by the stations. In addition, each set comprises IDs of a plurality of clusters, each cluster comprises at least one station of the MIMO communication system, and at least one cluster comprises more than one station of the MIMO communication system.

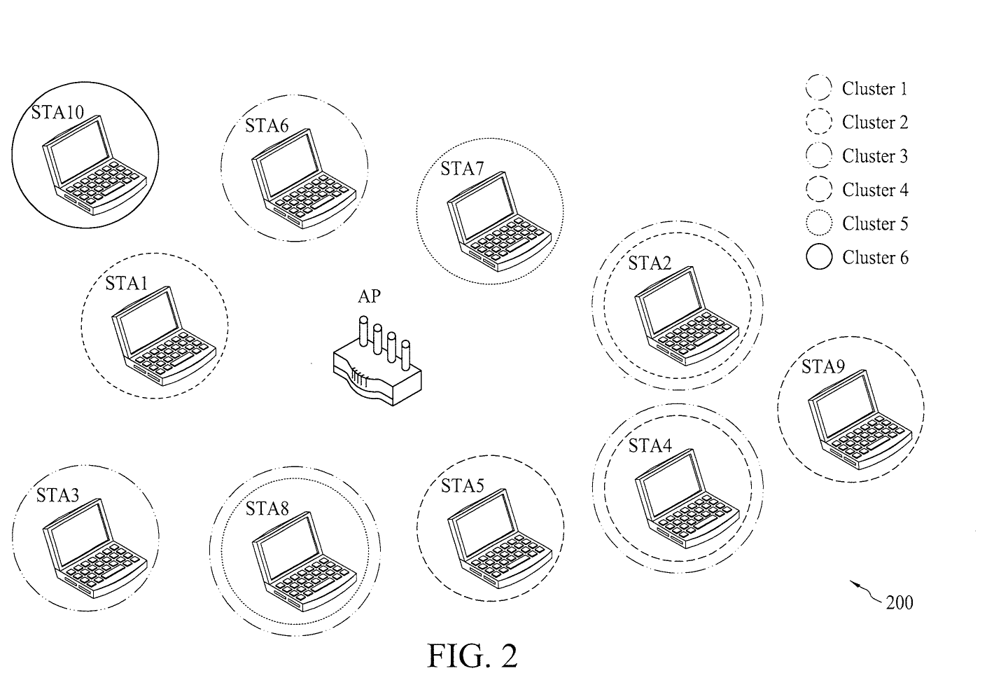

FIG. 2 shows a clustering assignment of a plurality of stations of a MIMO communication system according to an embodiment of the present invention. As shown in FIG. 2, the MIMO communication system 200 comprises ten stations STA1 to STA10. There are six clusters Cluster1 to Cluster6 in the MIMO communication system 200. In step 101 in FIG. 1, the stations STA1 to STA10 are assigned to the clusters Cluster1 to Cluster6 according to the spatial correlations between these stations. Accordingly, Cluster1 comprises station STA2; Cluster2 comprises stations STA1 and STA2; Cluster3 comprises stations STA3, STA4, STA6 and STA8; Cluster4 comprises stations STA4, STA5 and STA9; Cluster5 comprises stations STA7 and STA8; and Cluster6 comprises station STA10. In step 102 in FIG. 1, the clusters Cluster1 to Cluster6 are then assigned to a plurality of sets according to the spatial correlations between these stations. In this embodiment, Cluster3, Cluster1, Cluster5 and Cluster6 are assigned to Set1.

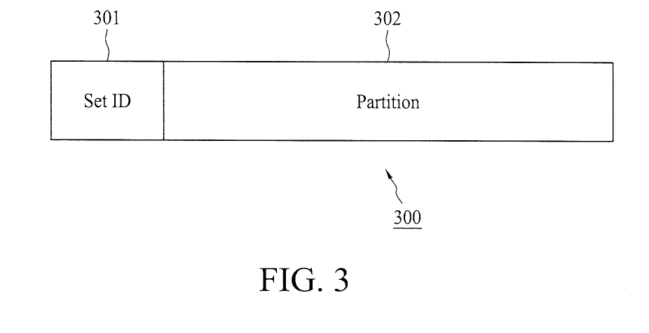

By obtaining the clustering assignment of the stations STA1 to STA10, the data transmission of STA1 to STA10 can be applied accordingly. In step 103 in FIG. 1, a plurality of data streams conforming to a MIMO communication system are transmitted, wherein each data stream comprises a same signal field indicating which stations of the MIMO communication system are to receive the data stream. In some embodiments of the present invention, the method is applied to the IEEE 802.11n standard or related standards. Accordingly, the signal field is in the very high throughput signal field (VHT-SIG) in preambles of the plurality of data streams. FIG. 3 shows the structure of a signal field according to an embodiment of the present invention. As shown in FIG. 3, the signal field 300 comprises a first column 301 containing a set ID and a second column 302 containing the partition of the plurality of data streams, which indicates which data streams are to be received by the stations.

All stations in the clusters within the same set ID try to decode the space-time streams according to Qk's and the definition of the set ID. If there are C clusters, and an ordered set S contains K clusters among C clusters, then the ordered set S can be denoted as S={element 1, element 2, . . . , element K}, wherein each element in S is a cluster. For example, set Set1={Cluster3, Cluster1, Cluster5, Cluster6}. Element k, wherein 1≦k≦K, is used to decode the space-time streams from

$${\sum }_{i = 1}^{k - 1} {Q}_{i} to {\sum }_{i = 1}^{k - 1} {Q}_{1} + {Q}_{k} .$$

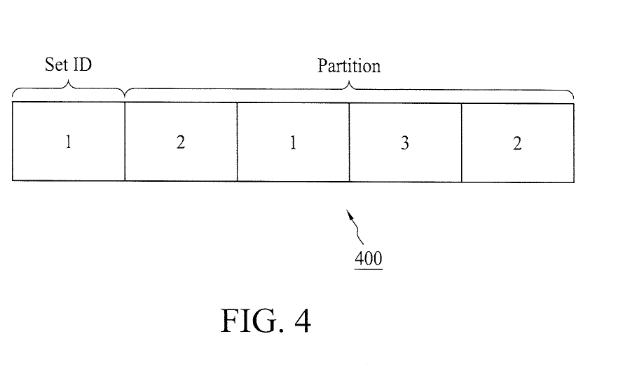

FIG. 4 shows a signal field according to an embodiment of the present invention. As shown in FIG. 4, the signal field 400 indicates that the stations in the set Set1 are to receive signals. In addition, the partition of the plurality of data streams is as follows: 2, 1, 3 and 2. Set1 can be denoted as Set1={Cluster3, Cluster1, Cluster5, Cluster6}, and Cluster3={STA3, STA4, STA6, STA8}, Cluster 1={STA2}, Cluster5={STA7, STA8} and Cluster 6={STA10}. Accordingly, the stations STA3, STA4, STA6 and STA8 decode the first and second data streams. The station STA2 decodes the third data stream. The stations STA7 and STA8 decode the fourth, the fifth and the sixth data streams. The station STA10 decodes the seventh and the eighth data streams.

In step 104, every station of a cluster in the set Set1 then decodes the corresponding data stream to determine which station of the cluster the data stream belongs to. That is, all stations of each cluster contained within Set1 then compare the MAC ID in the received frame with the MAC ID of themselves to determine whether they are the targeted station.

In some embodiments of the present invention, one station may be required to receive more than one data stream. For example, in the aforementioned embodiment shown in FIG. 4, the station STA8 receives the data streams for the clusters Cluster3 and Cluster5. One criterion is that such a station only receives the data streams corresponding to the cluster with a number of streams that is greater than the number of streams of the other clusters including the station. Applying this criterion to the aforementioned embodiment shown in FIG. 4, the station STA8 then only receives data streams of the cluster Cluster3. Another criterion is that such station only receives the data streams corresponding to the cluster with a number of streams that is smaller than the number of streams of other clusters including the station. Applying this criterion to the aforementioned embodiment shown in FIG. 4, the station STA8 then only receives data streams of the cluster Cluster5. Another criterion is that such station only receives the data stream corresponding to the cluster with the set ID having an order that is higher than the order of the set ID of the other clusters including the station. Applying this criterion to the aforementioned embodiment shown in FIG. 4, the station STA8 then only receives data streams of the cluster Cluster3. Another criterion is that such station only receives the data stream corresponding to the cluster with the set ID having an order that is lower than the order of the set ID of other clusters including the station. Applying this criterion to the aforementioned embodiment shown in FIG. 4, the station STA8 then only receives data streams of the cluster Cluster5. Another criterion is that such station does not receive any data stream. Applying this criterion to the aforementioned embodiment shown in FIG. 4, the station STA8 then does not receive any data stream.

Referring to the aforementioned embodiment shown in FIG. 4, the set Set1 can map to several combinations of stations. For example, the set Set1 can map to stations STA3 STA2, STA7 and STA10 or stations STA4, STA2, STA8 and STA10. Therefore, the method provided by the present invention provides versatility in terms of possible combination of stations.

In conclusion, the method for clustering multiple stations and the communication method provided by the present invention assigns a plurality of stations to a plurality of clusters and stations, and utilizes a signal field to indicate which stations are to receive the data stream. Accordingly, the targeted stations can be specified as soon as possible, e.g. in the preamble of the data streams. In addition, the list of the targeted stations is versatile and can be changed quickly.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for clustering multiple stations for a multiple input multiple output (MIMO) communication system, comprising the steps of:
assigning a plurality of stations of a MIMO communication system to a plurality of clusters, wherein each station is assigned to at least one cluster, and at least one cluster is assigned with more than one station; and
assigning the plurality of clusters to a plurality of sets, wherein each cluster is assigned to a set.

2. The method of claim 1, wherein the correlations between the stations in a cluster are above a threshold value.

3. The method of claim 2, wherein the spatial correlations between the stations in a cluster are above a threshold value.

4. The method of claim 1, wherein the correlations between the stations in different sets are below a threshold value.

5. The method of claim 4, wherein the spatial correlations between the stations in different sets are below a threshold value.

6. The method of claim 1, wherein each set comprises four clusters.

7. A communication method for a multiple input multiple output (MIMO) communication system, comprising a step of:
transmitting a plurality of data streams conforming to a MIMO communication system, wherein each data stream comprises a same signal field indicating which stations of the MIMO communication system are to receive the data stream;
wherein the signal field comprises information including an ID of one of a plurality of sets and a partition of the plurality of data streams, the ID of the set indicates which stations are to receive the data streams, and the partition of the plurality of data streams indicates which data streams are to be received by the stations;
wherein each set comprises IDs of a plurality of clusters, each cluster comprises at least one station of the MIMO communication system, and at least one cluster comprises more than one station of the MIMO communication system.

8. The communication method of claim 7, wherein the signal field is in a very high throughput signal field (VHT-SIG) in preambles of the plurality of data streams.

9. The communication method of claim 7, further comprising a step in which:
every station of a cluster in the set indicated by the signal field decodes the corresponding data streams to determine which station the data streams corresponding to the cluster belongs to.

10. The communication method of claim 9, wherein the determination of which station of a cluster the data streams belong to is performed by comparing media access control (MAC) ID in the received data streams and MAC ID of the stations.

11. The communication method of claim 9, wherein if there is more than one cluster corresponding to a station, the station only receives the data streams corresponding to the cluster with a number of streams that is greater than the number of streams of other clusters including the station.

12. The communication method of claim 9, wherein if there is more than one cluster corresponding to a station, the station only receives the data streams corresponding to the cluster with a number of streams that is smaller than the number of streams of other clusters including the station.

13. The communication method of claim 9, wherein if there is more than one cluster corresponding to a station, the station only receives the data streams corresponding to the cluster with an order in the set ID that is higher than the order in the set ID of other clusters including the station.

14. The communication method of claim 9, wherein if there is more than one cluster corresponding to a station, the station only receives the data streams corresponding to the cluster with an order in the set ID that is lower than the order in the set ID of other clusters including the station.

15. The communication method of claim 9, wherein if there is more than one cluster corresponding to a station, the station does not receive any data stream.

16. The communication method of claim 7, wherein the correlations between the stations in a cluster are above a threshold value.

17. The communication method of claim 16, wherein the spatial correlations between the stations in a cluster are above a threshold value.

18. The communication method of claim 7, wherein the correlations between the stations in different sets are below a threshold value.

19. The communication method of claim 18, wherein the spatial correlations between the stations in different sets are below a threshold value.

20. The communication method of claim 7, wherein each set comprises four clusters.
